(19) United States
(12) Patent Application Publication
(10) Pub. No.: US 2008/0260049 A1
(43) Pub. Date: Oct. 23, 2008

(54) SERIALIZER AND DESERIALIZER

(75) Inventor: John WOOD, Raunds, Wellingborough (GB)

Correspondence Address: DECHERT LLP, P.O. BOX 390460, MOUNTAIN VIEW, CA, 94039-0460, US

(73) Assignee: MultiGIG, Inc., Scotts Valley, CA (US)

(21) Appl. No.: 12/018,116

(22) Filed: Jan. 22, 2008

Related U.S. Application Data
(63) Continuation of application No. 11/755,505, filed on May 30, 2007, now abandoned.
Application No. 11/755,505 is a continuation of application No. 11/530,781, filed on Sep. 11, 2006, now abandoned.
(60) Provisional application No. 60/716,552, filed on Sep. 12, 2005.

(51) Int. Cl. H04B 3/50

(52) U.S. Cl. 375/257

(57) ABSTRACT

A system and method of transmitting and receiving bit serial information is disclosed. In a differential embodiment, serial bits are transmitted by a pair of line-matched differential drivers that are ac coupled to a two-conductor transmission line. A receiver is ac coupled to the line and receives the transmitted serial information via a high pass filter. The receiver includes a level-triggered latch that provides a threshold for receiving the serial information, changes state to reflect the received information, and then clamps the received information to the state of the latch. In a single-ended embodiment, the ac-coupled receiver receives the bit serial information via a high pass filter. The resistance for the filter is an active device that also provides a voltage threshold for the receiver. The received bit serial information changes the state of a device which then alters the threshold, via hysteresis, for the net bit of serial information.

### CROSS-REFERENCES TO RELATED APPLICATIONS

This application is a continuation of U.S. application Ser. No. 11/755,505, filed May 30, 3007, which is a continuation of U.S. application Ser. No. 11/530,781, filed Sep. 11, 2006, which claims the benefit of U.S. Provisional Application No. 60/716,552, filed Sep. 19, 2005, which provisional application is hereby incorporated by reference in its entirety.

### FIELD OF THE INVENTION

The present invention relates generally to a system and method for converting digital data from parallel to serial and serial to parallel and more particular to a SERDES transmission system.

### DESCRIPTION OF THE RELATED ART

FIG. 1A shows a conventional SERDES channel 10, which includes an input register 12, an encoder 14, a serializer 16, a driver 18, transmission line links 20, 22, receiver 24, a deserializer 26, a decoder 28 and an output register 30. The term SERDES is usually taken to mean a high-speed serial I/O channel using differential transmission and reception and often incorporating a DC-neutral coding scheme, such as the well-known 8b/10b encoding scheme, as shown in FIG. 1A. Alternatives to 8b/10b coding include Manchester encoding, which suffers from using two times higher bandwidth, and ‘scrambling,’ as used in the SDI video serial digital standard.

Line coding schemes, such as 8b/10b, consume too much power in coding/decoding and reduce bandwidth of the channel. It is also cumbersome to apply 8b/10b on each independent lane.

Scrambling, a technique where the output is ‘scrambled’ by mixing it with feedback to make a deterministic pseudo-random sequence which has statistically more bit-transitions than the original data stream, is “mostly” DC-neutral. Such a technique is illustrated in FIG. 1B. The advantage is that there is no loss of bandwidth, because the TX/RX pair still gets one bit out for one bit in and the determinism enables the receiver to decode on-the-fly with minimal complexity. However, in pathological cases, the output can be DC for long intervals of time, which often leads to problems. The scheme shown in the figure is also somewhat costly in area to apply on a per-lane basis.

Many digital circuits are inherently parallel, that is, eight bits typically are emitted per cycle, although it could be considered that each bit of the output is one bit of a multi-lane serial stream, e.g., bit 0 is an independent serial stream, bit 1 is an independent serial stream, etc. To interface with a standard type SERDES interface on, say, a device operating at 2 gigabits/sec without SERDES requires a parallel-to-serial conversion of bits 0-7 of a complete 8-bit word. Using a single-lane SERDES for an 8-bit bus thus requires that a shift register operate at 2 gigabits/sec×8=16 gigabits/sec to perform the parallel-to-serial conversion. If 8b/10b encoding is used this rises to 20 gigabits/second, because of the 20% bandwidth overhead incurred by the coding.

Architectures, such as PCI Express, have the ability to operate multiple lanes at 2.5 gigabits/second, where a lane contains a dual unidirectional path between two devices. The channels taken together have sufficient bandwidth. However, the problems of parallel-to-serial conversion, 8b/10b encoding, optional scrambling, and complex protocols remain if a device conforms to the PCI Express standard.

In PCI Express, the physical layer requires the use of differential signaling, AC coupling on the transmit side of the differential pair to eliminate the DC common mode element, and pre-emphasis to reduce intersymbol interference, which is typically measured with eye diagrams.

Much credence is given to eye diagrams and pre-emphasis, illustrated in FIG. 1C, to compensate for the effects of cable frequency dependent loss. Essentially the whole eye-diagram issue comes about from a couple of false constraints: (i) the threshold is fixed and unchanging (half way up the vertical axis on the eye diagram); and (ii) the channel has to pass (or be pre-compensated to pass) frequency components from bit-rate/2 to bit-rate/10 to with a flat response and low dispersion so that the voltage of many traces (each with different history of 0's and 1's) sweeps through the eye. This means the channel has to pass low frequency signals with high fidelity even though all the information is contained in the high frequency components.

### BRIEF SUMMARY OF THE INVENTION

A new approach takes advantage of differential of AC coupled signals but without loss of bit-rate and a dramatic reduction in power consumption relative to conventional high-speed serial approaches. Although AC coupling is used, the signaling scheme faithfully reproduces small-swing logic signals down to DC.

The signaling levels are compatible with commercial FPGA SERDES interface ports.

The SERDES Data is not parallel-to-serial converted; each bit is considered as an independent lane in a multiple lane serial channel. This differs from an ordinary parallel bus in the ability to accommodate large skews between lanes.

One embodiment of the present invention is a bit serial transmitter device. The device includes a driver circuit and first and second capacitors. The driver circuit is operative to establish a first differential voltage between a first node and a second node, where the first differential voltage is a difference between a first voltage and a second voltage, and operative to establish a second differential voltage between the first and the second nodes, where the second differential voltage is a difference between the second voltage and the first voltage, and where the driver circuit has a drive impedance that matches the impedance of a two-conductor transmission line. The first coupling capacitor is connected between the first node and the first conductor of the two-conductor transmission line, and the second coupling capacitor is connected between the second node and the second conductor of the two-conductor transmission line.

Another embodiment of the present invention is a bit serial receiver device for a two-conductor transmission line. This device includes a pair of capacitors, a pair of pullups and differential level-triggered latch. The first of the pair of capacitors is coupled between a first conductor of a two-conductor transmission line and a first node, and the second of the pair of capacitors is coupled between a second conductor of the two-conductor transmission line and a second node. The first of the pair of pullups is connected between the first conductor and a first voltage and the second of the pair of pullups is connected between the second conductor and the first voltage. The differential level-triggered latch has a first input that is connected to the first node and a second input connected to the second node. The differential latch has an adjustable threshold voltage such that a first differential voltage between the first and second conductors and greater than the threshold voltage sets the latch in a first state and a second differential voltage between the first and second conductors and greater than the threshold voltage sets the latch in a second state.

Yet another embodiment of the present invention is a system of bit serial transmitter channels. The system includes a reference voltage generator, a first bit serial transmitter device, and a second bit serial transmitter device. The reference voltage generator provides first, second, third and fourth reference voltages. The first bit serial transmitter device establishes a first and second differential voltage between a first and second conductor of a first two-conductor transmission line based on the first and second reference voltages. The second bit serial transmitter device that establishes a first and second differential voltage between a first and second conductor of a second two-conductor transmission line based on the third and fourth reference voltages.

Yet another embodiment is bit serial receiver device for a single conductor transmission line. The device includes a coupling capacitor, an active resistance device, an inverting transconductance amplification element, and a feedback path. The coupling capacitor is connected in series between a single conductor transmission line and a receive node. The active resistance device provide a voltage source and a resistance between the receive node and the voltage source, where the voltage source sets a voltage threshold for the receiver. The inverting transconductance amplification element is connected to an output of the active resistance device, where the inverting element is operative to invert the output of the active resistance device. The feedback path is connected between an output and an input of the inverting transconductance amplification element and provides hysteresis to the voltage source of the active resistance device.

Yet another embodiment is a method for receiving a bit serial transmission. The method includes the steps of (i) receiving a bit serial differential transmission via a high pass filter, (ii) determining whether or not a received transmission exceeds a threshold of a level-triggered latch, and (iii) if the received transmission exceeds the threshold, changing the state of the level-triggered latch and clamping the received transmission to a voltage provided by the level-triggered latch.

Yet another embodiment is a method for receiving a bit serial transmission. The method includes (i) receiving a bit serial single-ended transmission via a high pass filter, (ii) determining whether or not a received transmission exceeds a threshold of an active resistance device, and (iii) if the received transmission exceeds the threshold, changing the state of an inverting transconductance amplification element connected to the active resistance device, altering the threshold of the active resistance device, and clamping the received transmission to a voltage provided by the active resistance device.

### BRIEF DESCRIPTION OF THE DRAWINGS

These and other features, aspects and advantages of the present invention will become better understood with regard to the following description, appended claims, and accompanying drawings where:

FIG. 1A shows a conventional SERDES channel;

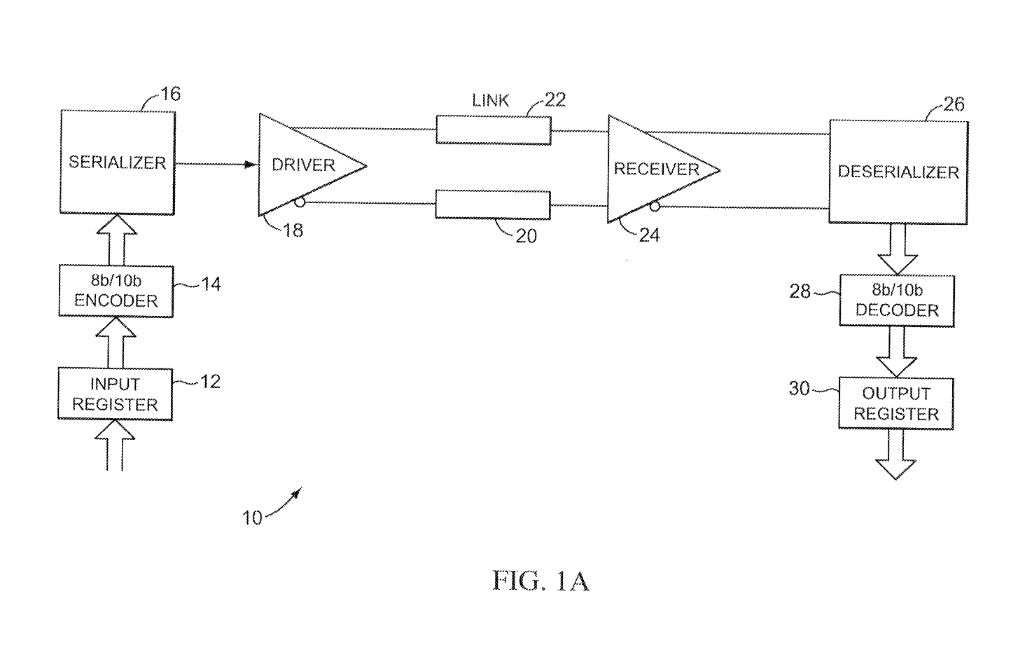

FIG. 1B shows an SDI encoder and decoder. The SDI encoder produces a scrambled NRZI bit stream. 8B10B encoding is NOT used;

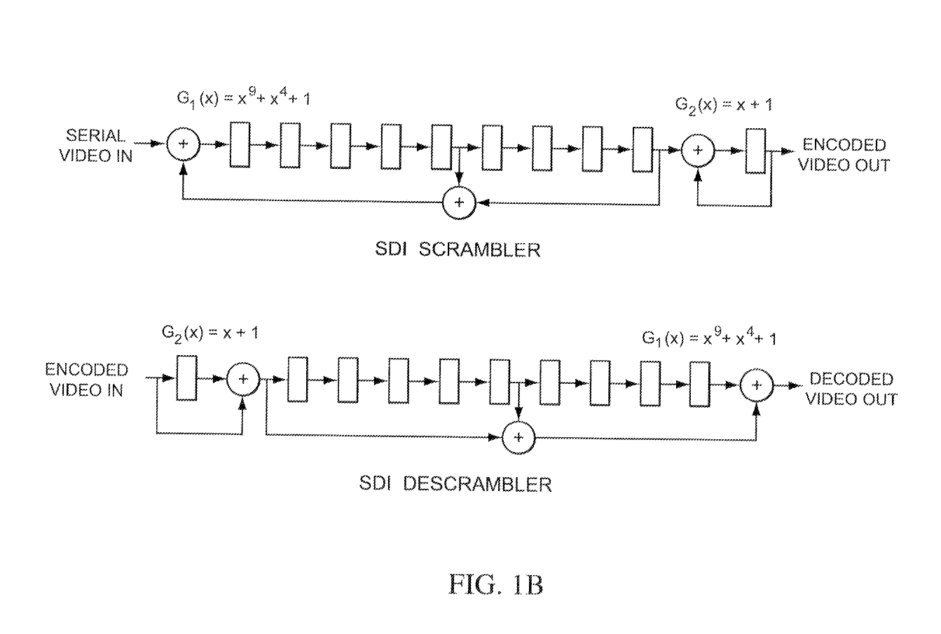

FIG. 1C shows a binary eye pattern for a conventional SERDES circuit with pre-emphasis;

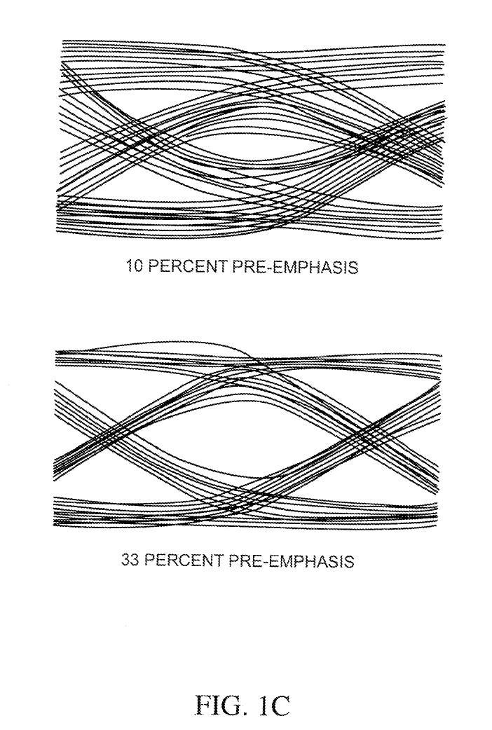

FIG. 2 shows a SERDES transmitter in one embodiment of the present invention. The figure includes a low power (shared current) dual output SERDES transmitter with 100 ohm source impedance, featuring multiple independent TX channels at PCI-Express Mobile signal levels (500 mV p-p) from 2.5 mA. Note: Typical values and transistor widths shown. 25% pre-emphasis optional (probably not needed). Termination (possibly at not characteristic);

FIG. 3A shows a differential SERDES receiver in one embodiment of the present invention. Power-saving ‘active termination.’ Note: additional Pfet version of this stage can be stacked above and share vrx as a common series-connected power supply and share current source. Turnable or fixed. Until get no ripple from S/H. Hysteresis adjusts apparent V. Resistor/voltage equivalence. DC termination (not necessarily characteristic);

FIG. 3B shows a single-ended SERDES receiver in another embodiment of the present invention;

FIG. 4 shows waveforms for the input, output and transmission line signals for an embodiment of the present invention;

FIG. 5 shows waveforms for the input and output signals of a stacked set of transmitters;

FIGS. 6A and 6B show waveforms for a single-ended SERDES receiver of the present invention; and

FIG. 7 shows a system for deskewing SERDES channels. De(pre) Skew circuit. Split path for extra timing tenability and skew tolerance. Two paths needed for one channel. ⅛ phase trimability for simple 2 phase converter. 1/16^{th} or better for multi-rotation converter. Delay=1 . . . 5 cycles. Phases assuming a 32 phase (16 segments).

### DETAILED DESCRIPTION OF THE INVENTION

### Transmitter

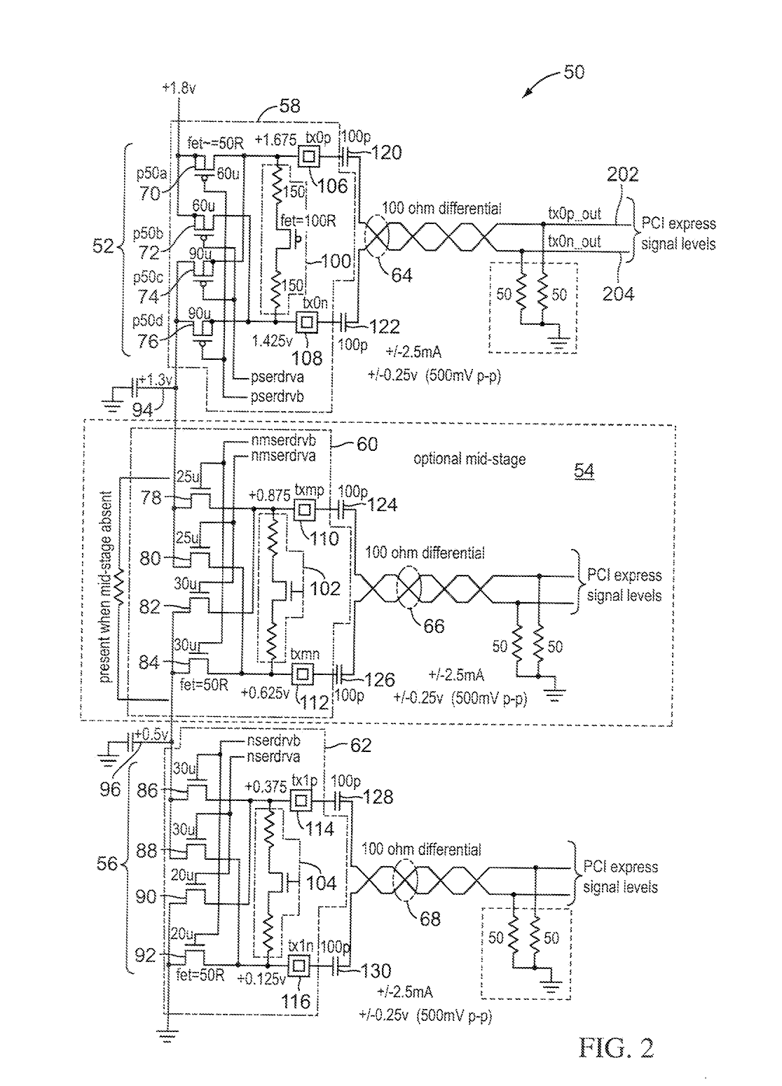

One objective of the present invention is power savings. The first power-saving possibility comes from transmitting signal levels that are much smaller than VDD. FIG. 2 illustrates a SERDES transmitter 50 in accordance with an embodiment of the present invention. There are three SERDES channels 52, 54, 56 shown, though the mid-stage channel 54 is optional. The transmitter 58, 60, 62 for each channel is designed to transmit a differential positive or negative voltage on a 100 ohm differential pair 64, 66, 68. The figure shows how a full-bridge FET switch 70-76, 78-84, 86-92 can drive a push-pull differential signal with small swings, i.e., without the need of a full VDD swing. The circuits are double pull-double throw (DPDT) analog switches whose series resistance is set to suit the transmission-line medium's characteristic impedance. Choosing the transistor sizes to have nominally 50 ohms on-resistance provides a ‘back-termination’ resistance to the transmission-line and this is a very important feature to the second source of power saving, that coming from the receiver implementation. The same supply current passes through all channels which are effectively ‘in-series’, splitting the supply voltage VDD among them. Although not shown, active regulators can control the intermediate voltages 94, 96 and shunt-type regulators operating between the different supply rails would still keep the currents shared.

To stack two circuits on a 1.8 v CMOS process, PFETs 70, 72, 74, 76 are chosen to switch the top-side and NFETs 86, 88, 90, 92 to switch the bottom sides. The figure shows a third ‘middle’ channel, which uses NFETs 78, 80, 82, 84, but with the option of having the higher-voltage FET operate as a source-follower (again sized for approximately Z0/2 characteristic resistance).

The SERDES transmitter differential voltage is 500 mV p-p (±250 mV) in accordance with PCI-Express Mobile signal levels. Current in the differential pair of conductors is ±2.5 mA. The transistors that establish the positive or negative differential voltage are coupled to the line capacitively, so that the average DC voltage level on the line is zero. An optional pre-emphasis circuit 100, 102, 104 is provided.

Transistors p50a 70 and p50d 76 each have a gate connected to signal pserdrvb. Transistors p50b 72 and p50c 74 each have a gate connected to signal pserdrva. When pserdrvb is on (low), transistors p50a 70 and p50d 76 drive the transmission line 64 with a differential voltage on tx0p 106 that is more positive than tx0n 108 and equal to approximately 250 mV. When signal pserdrva is on (low), transistors p50b 72 and p50c 74 drive the transmission line 64 with a differential voltage on tx0p 106 that is more negative than tx0n 108 and equal to approximately 250 mV.

In the middle channel, transistors 78 and 84 each have a gate connected to signal nmserdrvb. Transistors 80 and 82 each have a gate connected to signal nmserdrva. When nmserdrvb is on (low), transistors 78 and 84 drive the transmission line 66 with a differential voltage on txmp 110 that is more positive than txmn 112 and equal to approximately 250 mV. When signal nmserdrva is on (low), transistors 80 and 82 drive the transmission line 66 with a differential voltage on txmp 110 that is more negative than txmn 112 and equal to approximately 250 mV.

In the bottom channel, transistors 86 and 92 each have a gate connected to signal nserdrvb. Transistors 88 and 90 each have a gate connected to signal nserdrva. When nserdrvb is on (low), transistors 86 and 92 drive the transmission line 68 with a differential voltage on tx1p 114 that is more positive than tx1n 116 and equal to approximately 250 mV. When signal nserdrva is on (low), transistors 88 and 90 drive the transmission line 68 with a differential voltage on tx1p 114 that is more negative than tx1n 116 and equal to approximately 250 mV.

Note that, for the transmitter circuit driving an AC-coupled transmission line, the DC power consumption falls to zero if the output codes do not change. This encourages the use of Grey coding in the output bits rather than binary for the transmitter data source. Stacking the transmitters ‘in series’ saves power by running three channels from the same current, but has the problem that the DC levels of each output are very different. The capacitor coupling 120, 122, 124, 126, 128, and 130 eliminates the DC component to make each output identical in signal level at the transmission-line medium.

### Receiver

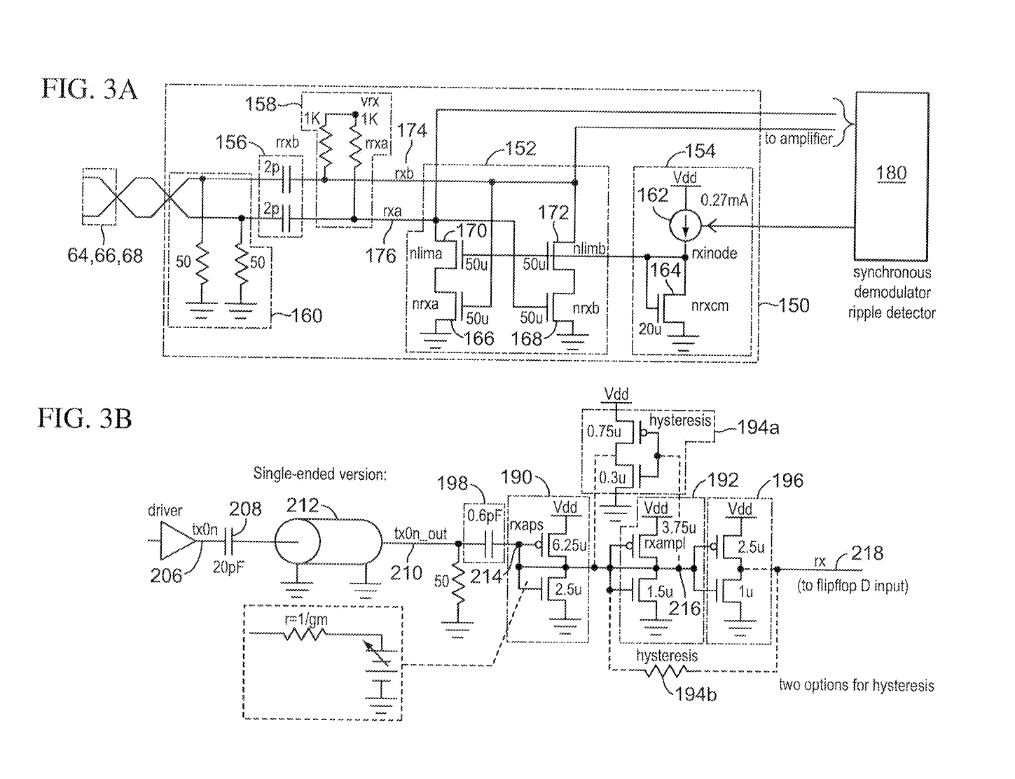

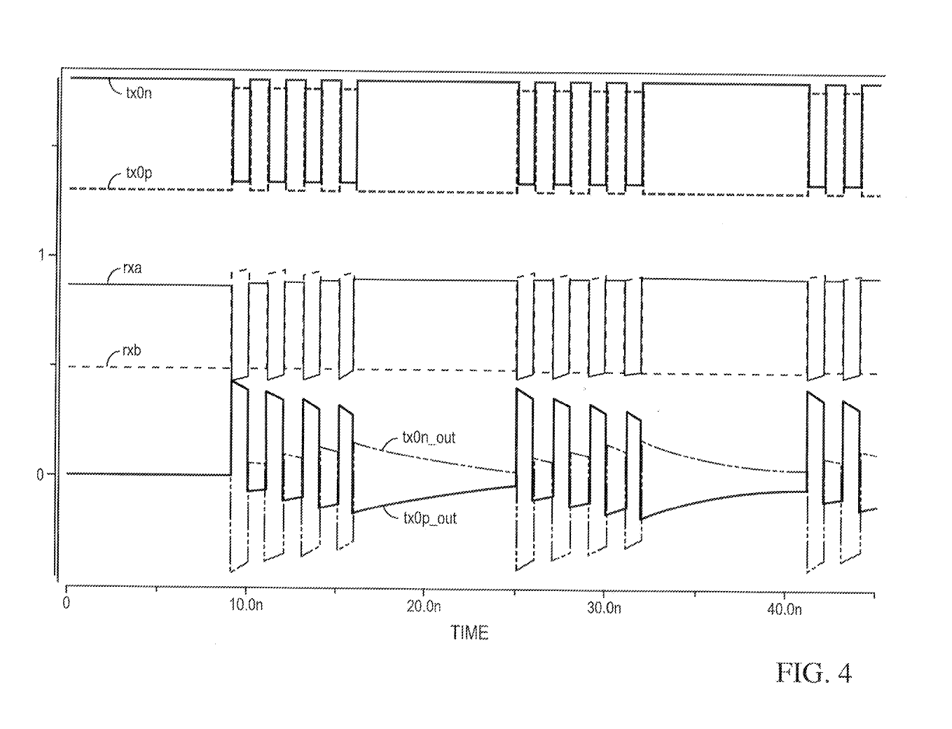

FIGS. 3A and 3B each illustrate a SERDES receiver in accordance with the present invention. For each of the channels described above, there is a SERDES receiver such as the one shown in FIG. 3A or FIG. 3B. The receiver, as a low-power design outlined here, is suitable as an IP block or as an interface chip. The receiver combines the functions of termination and a receive amplifier.

The SERDES receiver 150 in an embodiment of the present invention includes, in FIG. 3A, a level-triggered latch 152 that differentially senses a voltage change on the differential pair of conductors, one of 64, 66, 68, and holds the last detected state, a current source 154 for the latch 152, a pair of capacitors 156 for coupling the latch 152 to the differential pair of conductors, one of 64, 66, 68, a pair of pullups 158 connected to the latch 152, and a pair of DC terminators 160 whose value may not necessarily be that of the characteristic impedance of the differential conductor pair, one of 64, 66, 68.

The receiver 150 is designed to allow for AC coupling but does not need any kind of special DC balanced coding scheme and has full channel capacity. This is different from an 8b/10b scheme where the medium has to be designed to pass very high fidelity signals over a range of the bit-rate/5 to the bit-rate/2, making the effective bandwidth needed much more than 2:1 if margin is given for the simplistic RC coupling nature of the filtering. The circuit of the present invention operates by simply ignoring the low-frequency droop (which occurs as a consequence of having a potentially DC output scheme) using an RC filter and level-triggered latch 152. An optional approximate doubling of voltage through high-impedance termination can help to save more power.

The level triggered latch 152 has an apparent threshold of zero-differential because the latch 152 is similar to a differential amplifier. In terms of a received signal, the latch begins to move from its bistable state when the positive (+) and negative (−) inputs are not the same potential. Beyond this threshold, the latch 152 tends to amplify the imbalance and help the swing toward the other bistable state. The ‘droopy’ nature of the signals at the receiver termination resistors 160, though appearing unacceptable for a conventional receiver, is of no concern here, as no circuit in the present invention directly senses these signals relative to a particular fixed ground or voltage reference through a DC connection.

Ideal latch 152 operation occurs where the received signal at transition coincides with the self-bias ‘flip-voltages’ (that is, the bistable voltages which the latch would retain if the input were disconnected). For a frequency-dependent lossy medium, the expected increasing swing measured beyond the transition time is largely absorbed by the highpass filter on the front end.

The current source 154 includes a programmable reference source 162 and a transistor nrxcm 164, which is diode-connected. The gate voltage of transistor nrxcm 164 sets the current in transistors nrxa 166 and nrxb 168 via transistors nlima 170 and nlimb 172 of the latch 152. The sensitivity of the latch 152 is set by the amount of current in the latch 152. When a positive voltage change occurs on the differential pair of conductors, one of 64, 66, 68, a positive going pulse is produced on rxb 174 compared to rxa 176. This causes transistor nrxa 166 to turn on and transistor nrxb 168 to turn off. Because the gate of transistor nrxa 166 is connected to the drain of transistor nlimb 172 and the gate of transistor nrxb 168 is connected to the drain of nlima 170, the latch holds, on the transmission line, the last sensed change on the differential pair of conductors, one of 64, 66, and 68. When a negative voltage change occurs on the differential pair of conductors, a negative going pulse is produced on rxb 174 compared to rxa 176. This pulse turns on transistor nrxb 168 and turns off transistor nxra 166, holding a new state on the differential pair of conductors.

The pair of capacitors 156 that couple the latch 152 to the differential pair of conductors, one of 64, 66, 68, and the pair of pullup resistors 158 set an RC time constant that is longer than a single bit time on the line. This permits more than the coupling of the wavefront of the change on the line to the latch and allows the latch to have an effect on the line.

Pre-emphasis is not strictly necessary here even if the channel has a lot of frequency dependent attenuation. With the correct choice of the RC time constants, only transitions are acted upon by the latch 152 not the actual level of the inputs. Also, there is little memory of previous bits that is longer than a bit time. In fact, the latch tends to counteract any rise of signal level beyond the first transition, automatically compensating, to some extent, for dispersion. It is very important to note that the circuit is not a differentiator and not subject to high-f noise sensitivity. As stated above, all of the time constants are on the order of or longer than one bit time. In the example circuits given, the RC time constant of the transmitter circuit is about 100 pF×50Ω=5 ns and the time-constant of the latch is 1 kΩ×2 pF=2 ns. The signals at rxa 176 and rxb 174 are substantially faithful reproductions of the signals transmitted on the transmission-lines but with substantially all DC and low-frequency components removed. Higher-than-threshold swings (overdrive) of the input stage are also acceptable and the circuit behaves properly, but it is best to adaptively adjust the threshold for optimum noise immunity.

### Adaptive Termination

An improved implementation self-trims on a bit-by-bit (or longer) basis to adjust the input “threshold” of the level-triggered latch. Given that the current bias in the latch effectively sets the ‘flip-voltages’ of the latch 152 and the ‘threshold’ is exactly half of this ‘flip-voltage’ difference (the signal level which needs to be overcome to change the input state), there is a mechanism to alter the threshold. Ideally, the input signal flips at exactly double this minimum. To determine when the correct threshold is achieved, a ‘ripple detector’ circuit 180 acts as a synchronous demodulator detector with an output corresponding, +ve or −ve differentially, to the overshoot or undershoot relative to twice the threshold. When operating at the correct threshold (bias current 162 sets this) there is nearly zero output from the synchronous demodulator/detector and the overshoot and undershoot are approximately equal.

A feature of this circuit is zero static power in the transmitter. Unlike the schemes which prohibit DC content at the source, in the present invention the transmission-line current quickly and beneficially falls to zero when a continuous string of zeros or ones is sent.

### Single-Ended Implementation

The example given has been for a differential signaling format. An equivalent single-ended system is straightforward and can potentially increase bandwidth or reduce pin count. Most of the signal integrity advantages attributable to differential systems are achieved here by AC coupling and low-frequency rejection of the highpass filter(s). To refute the generally held belief that differential is the only way to achieve low noise, it should be noted that Low-noise RF sources have historically always been single-ended while the noise immunity is achieved via the frequency selectivity of the RF circuit. Commercial Ultra-low AM and PM noise frequency synthesizers universally use 50 ohm coaxial single-ended cable and connectors.

A single pole RC highpass filter is shown in FIG. 3B, but a multi-pole RC or other kind of filter can be used. Low frequency noise is totally unimportant. Again, note that this is not a differentiator, the time-constant is generally not much less than 1 bit time or higher.

FIG. 3B shows the circuitry needed for single-ended receiver. In the preferred implementation, a design without resistors and utilizing matched transistors has four main parts, (i) an active resistance device 190, (ii) a first inverting transconductance amplification element 192, (iii) a feedback path for hysteresis 194a,b, and (iv) inverting transconductance amplification element 196. The second inverting transconductance amplification element 196 is optional and helps to bring the received signals to full logic levels. The active resistance device 190, such as a self-biased CMOS inverter (the output of the inverter is connected to the input), is used to implement the input “resistor.” The resistor works with the input coupling capacitor 198 (probably on-chip) to form a single pole highpass filter. The self-biased CMOS inverter 190 has a stable voltage point that is approximately ½ VDD, but the resistance looking into the common output/feedback node is 1/gₘ of the devices, where gₘ is the transconductance of the transistor. This resistance is typically 550 ohms with the transistor sizes shown. Therefore, the highpass filter has a pole at 1/RC=1/(550×0.6 pF)≈0.5 GHz. In one embodiment, the first and second inverting transconductance amplification elements 192, 196 are first and second CMOS inverters. The first CMOS inverter 192 has a standard inverter configuration with fairly large transistors. The feedback transistors 194a in the feedback path, smaller in size than those in the first inverter 192, have a standard inverter configuration and create hysteresis around the threshold of the self-biased inverter 190. The second inverter 196 is configured to boost the rxampl signal to a full swing logic at the rx output in order to drive a flip-flop D input (not shown). The self-bias and input filter also help to reject power supply noise.

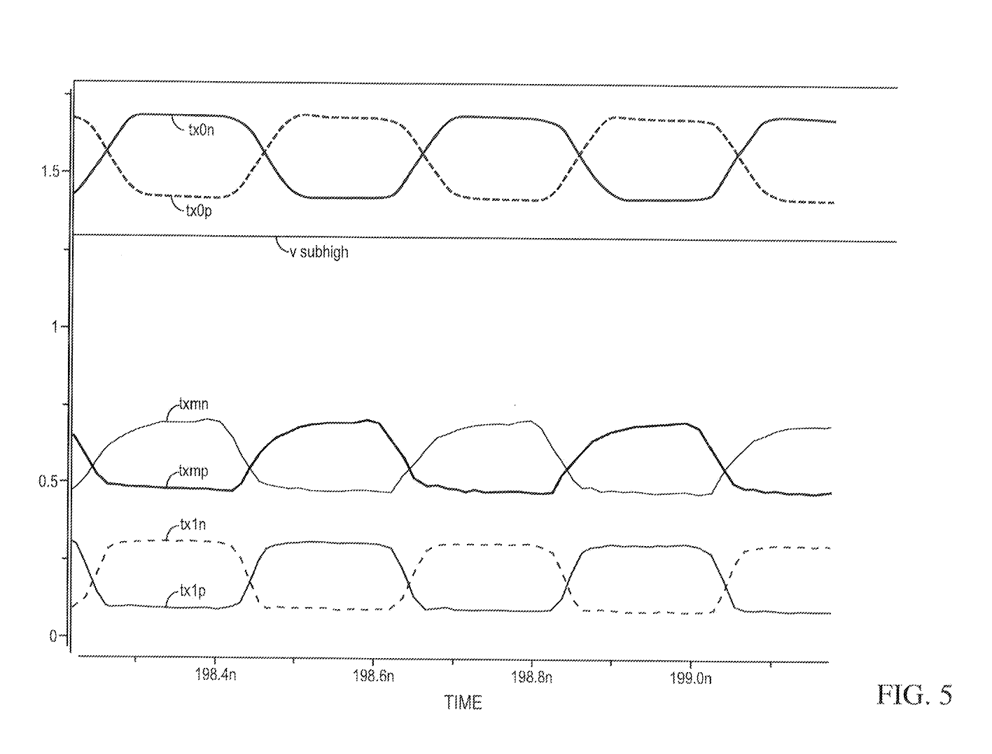

FIG. 4 shows waveforms for the input, output and transmission line signals for an embodiment of the present invention. The top traces are the waveforms at 1G bits/second on the transmit nodes tx0p 106 and tx0n 108 of FIG. 2. The bottom traces are the waveforms for the transmitted data on the transmission line conductors tx0n_out 204 and tx0p_out 202. The middle traces show the waveforms at the receive nodes rxa 176 and rxb 174 of FIG. 3A.

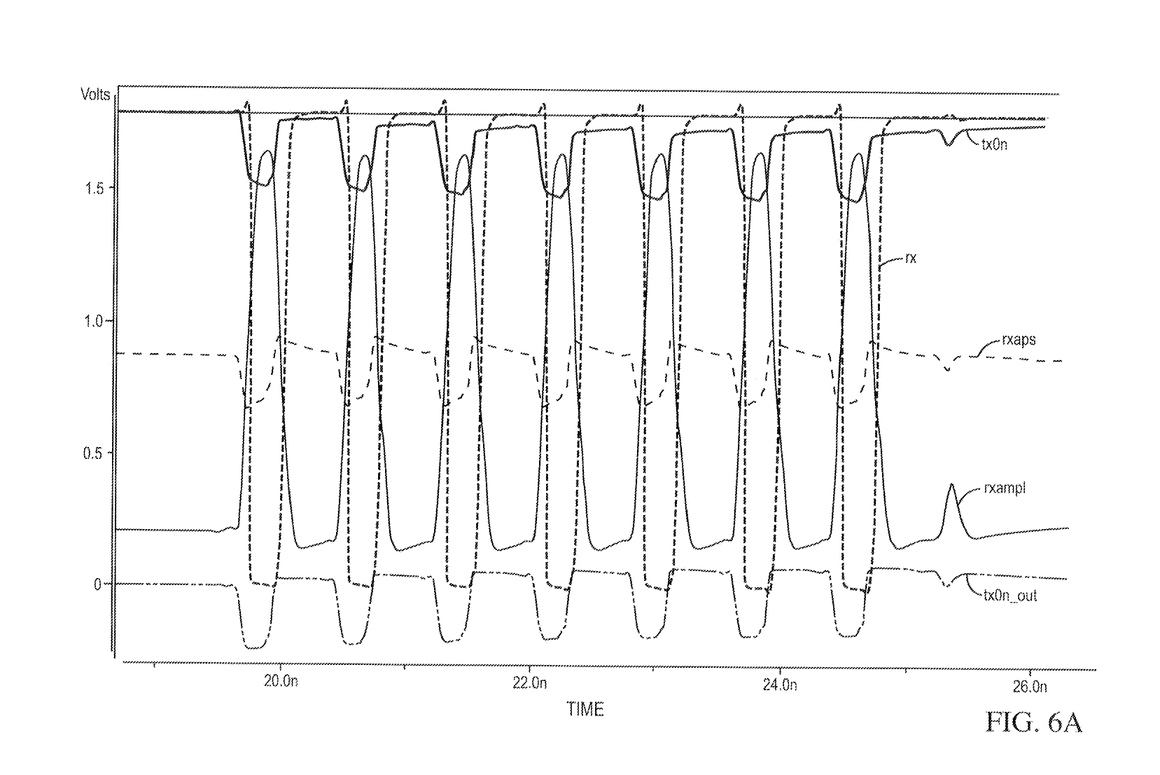

FIG. 5 shows waveforms for the input and output signals of a stacked set of transmitters, such as those shown in FIG. 2. The transmitter waveforms are at 5 G bits/second driving 100 ohms. The top traces show the waveforms for nodes tx0p 106 and tx0n 108. The middle traces are waveforms for txmp 110 and txmn 112 and the bottom traces are for nodes tx1p 114 and tx1n 116. Total supply current is 7 mA for 3 drivers fully active (falling to zero power for long stings of 0's or 1's.).

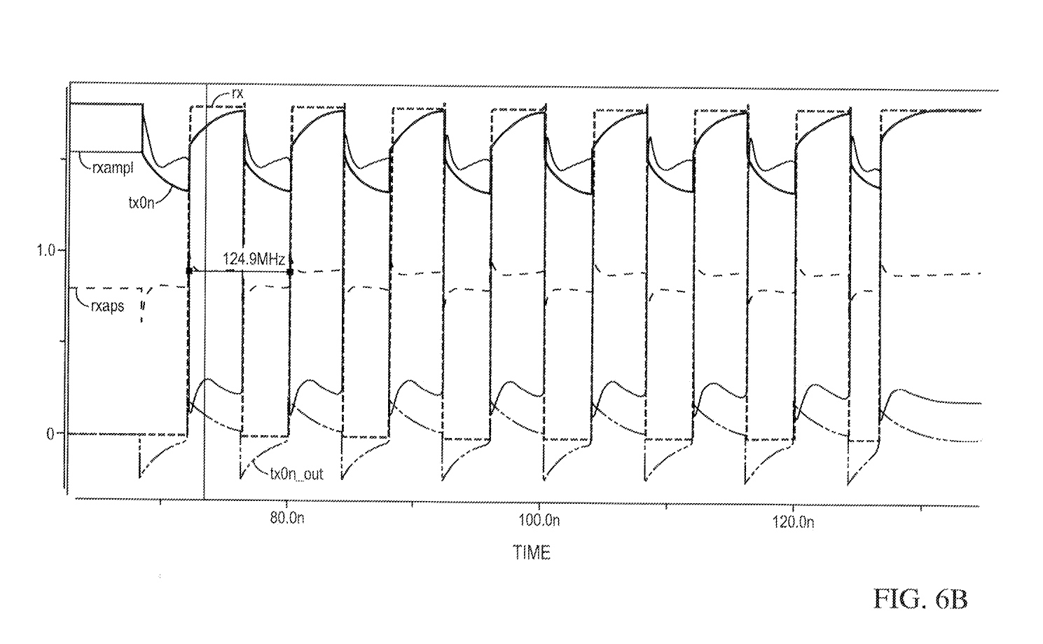

FIG. 6A shows transmitter and receiver waveforms for a single-ended SERDES receiver of the present invention. Signal tx0n 206 is the output of the driver before the coupling capacitor 208. Signal tx0n_out 210 is the waveform on the transmission line 212. Signal rxaps 214 is the waveform after the receiver coupling capacitor 198. The latter waveform is similar to tx0n_out 210, except for the RC droop towards the hysteresis levels. Signal rxampl 216 is the amplified version of received signal rxaps 214 and signal rx 218 is the boosted inversion of the rxampl signal 216, with basically logic level swings. Power consumption is 0.4 mA per RX channel at 2.5 Gbps, 0.6 mA @ 6.125 Gbps, on 0.18 u CMOS. The circuit can operate up to about 6 Gbps.

FIG. 6B shows waveforms for a single-ended SERDES receiver at a slower frequency. The waveforms are for 500 Mbps (or several 0s then several 1's at the higher rate). Note the RC time constant of the pull to the appropriate threshold on rxaps 214, and strong attenuation of dispersion-type peaking on tx0n 210 waveform by the combined filter action.

### Programmable Per-Bit Skew

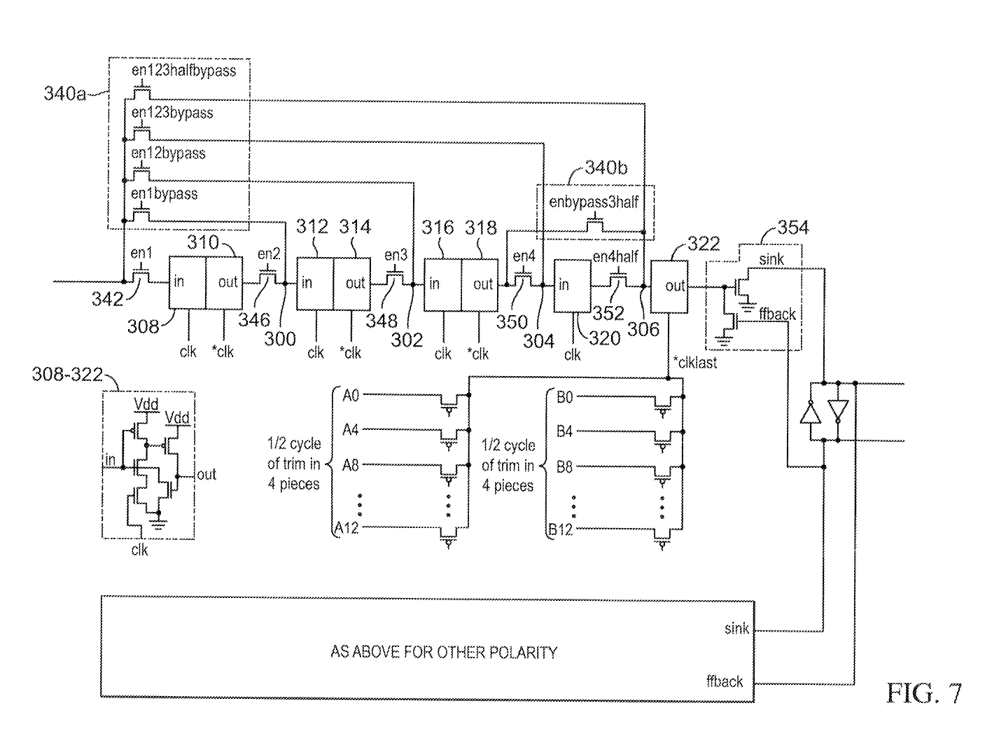

At high speeds, the individual lanes of high speed bus can experience misalignment. FIG. 7 shows a system for deskewing SERDES channels. As a service to the receiver (where there may not be a multi-phase clock available), variable phase taps 300, 302, 304, 306 per lane can skew the transmitted data outputs on a pin-by-pin basis by fractions of a cycle by means of enables 342, 352 and bypass enables 340a,b. The receiver circuit can send control signals back to the transmitter device to adjust the timing until the receiver detects low error rates, or a ‘round-trip’ calibration can be performed where, selectively, (under control of the transmitter) the receiver loops back, one at a time, one of its received signals to the transmitter where they can all be compared and de-skewed to the same level. Skew control taps can be ¼ or ⅛ of a cycle (finer for circuits that use multi-frequency rotary clocks). FIG. 7 shows how the last stage 320 322 is able to be skewed with a variable-skew clock. This variable-skew clock is to be derived from phase-interpolation if needed. The method shown has individual paths (split paths) for positive and negative edge delays. This helps with skew tolerance along the delay line and allows for fully independent trim of rising and falling edge location on a per-pin basis accounting for one of the largest causes of waveform asymmetry.

Especially suited for providing the skew control taps (A0-A12, B0-B12 in FIG. 7), and the clocks for stages is a rotary traveling wave oscillator such as that described in U.S. Pat. No. 6,656,089, which patent is incorporated by reference into the present application.

### Clocking

Clocking for the receiver can be provided as a ‘source-synchronous clock’ from the transmitter data source, i.e., one channel of the transmitter data source is dedicated to a clock output. An alternative is that the transmitter and receiver are both phase-locked to a common source already and have any required PLL circuits within.

### Transition Rate Increase

The source of data for the transmitter can spend indefinite amounts of time with a single output code which is good for power consumption, but, if there is a desire to increase the transition rate, a single 8-bit linear feedback shift register (LFSR) can be added. The LFSR output bits are XOR'ed with the corresponding output bits prior to being sent to the transmitter's drivers. This insures a large number of transitions in the output but does not insure DC neutrality (which is not a problem). The receiver detects the state of the LFSR in the transmitter (which it must do to be able to decode the stream) by first forcing a 0 code, prior to the XOR, and looking for a specific character in the LFSR sequence. Note that adding transitions raises the power consumption as mentioned previously. The LFSR need not be clocked at the full clock rate, just fast enough to give some activity.

Although the present invention has been described in considerable detail with reference to certain preferred versions thereof, other versions are possible. Therefore, the spirit and scope of the appended claims should not be limited to the description of the preferred versions contained herein.

What is claimed is:

1. A bit serial transmitter device comprising:
a driver circuit operative to establish a first differential voltage between a first node and a second node, the first differential voltage being a difference between a first voltage and a second voltage, and operative to establish a second differential voltage between the first and the second nodes, the second differential voltage being a difference between the second voltage and the first voltage, the driver circuit having a drive impedance that matches the impedance of a two-conductor transmission line; and
first and second capacitors, the first coupling capacitor connected between the first node and the first conductor of the two-conductor transmission line, and the second coupling capacitor connected between the second node and the second conductor of the two-conductor transmission line.

2. A bit serial transmitter as recited in claim 1, wherein the driver circuit includes:
a first pair of drivers that establishes the first differential voltage, each of the drivers having a drive impedance of half of a two-conductor transmission line; and
a second pair of drivers that establishes the second differential voltage, each of the drivers having a drive impedance of half of the two-conductor transmission line.

3. A bit serial transmitter as recited in claim 2, wherein each of the first pair of drivers is a PMOS transistor, each said PMOS transistor having a gate and a source and drain with a channel between the source and drain, the channel of the first of the pair of transistors being connected between the first voltage and the first node, the channel of the second of the pair of transistors being connected between the second voltage and the second node.

4. A bit serial transmitter as recited in claim 2,
wherein each of the second pair of drivers is a PMOS transistor, each said PMOS transistor having a gate and a source and drain with a channel between the source and drain, the channel of the first of the pair of transistors being connected between the second voltage and the first node, the channel of the second of the pair of transistors being connected between the first voltage and the second node.

5. A bit serial transmitter as recited in claim 1, further comprising a pre-emphasis circuit connected between the first and second nodes.

6. A bit serial transmitter as recited in claim 1, wherein the pre-emphasis circuit includes:
a pair of resistors; and
a transistor having a gate, source and drain, and a channel between the source and drain, the pair of resistors and the channel of the transistor being connected in series between the first and second nodes, the gate of the transistor having a signal that enables or disables the circuit.

7. A bit serial transmitter as recited in claim 1, wherein the first and second coupling capacitors each have a value of approximately 100 picofarads.

8. A bit serial transmitter as recited in claim 1, wherein the two-conductor transmission line has a characteristic impedance that is approximately 100 ohms.

9. A bit serial transmitter as recited in claim 1, wherein the first differential voltage is approximately +250 millivolts.

10. A bit serial transmitter as recited in claim 1, wherein the second differential voltage is approximately −250 millivolts.

11. A bit serial receiver device comprising:
a pair of capacitors the first of the pair of capacitors coupled between a first conductor of a two-conductor transmission line and a first node, the second of the pair of capacitors coupled between a second conductor of the two-conductor transmission line and a second node;
a pair of pullups, the first of the pair of pullups connected between the first conductor and a first voltage, the second of the pair of pullups connected between the second conductor and the first voltage; and
a differential level-triggered latch having a first input connected to the first node and a second input connected to the second node, the differential latch having an adjustable threshold voltage such that a first differential voltage between the first and second conductors and greater than the threshold voltage sets the latch in a first state and a second differential voltage between the first and second conductors and greater than the threshold voltage sets the latch in a second state.

12. A bit serial receiver device as recited in claim 11, wherein the differential level-triggered latch includes
first, second, third and fourth transistors, each having a gate, source and drain, with a channel between the source and drain,
wherein channels of the first and third transistors are connected in series and between the first conductor and a second voltage,
wherein the channels of the second and fourth transistors are connected in series and between the second conductor and the second voltage,
wherein the gate of the first transistor is connected to the second conductor and the gate of the second transistor is connected to the first conductor, and
wherein the gates of the third and fourth transistors are connected to an adjustable voltage that sets the threshold voltage of the latch.

13. A bit serial receiver device as recited in claim 12, further comprising:
an adjustable current source having an adjustment input for setting the current in the current source; and
a diode-connected transistor having a gate, source and drain and a channel between the source and drain, wherein the channel of the diode-connected transistor is connected between the current source and the second voltage.

14. A bit serial receiver device as recited in claim 14, further comprising a ripple detector circuit having a first input connected to the first conductor, a second input connected to the second conductor, and an output that is connected to the adjustment input of the current source, the ripple detector circuit being operative to detect differentially an overshoot or undershoot voltage relative to twice the threshold voltage of the latch and to adjust the current source such that the overshoot and undershoot are approximately equal.

15. A system of bit serial transmitter channels, the system comprising
a reference voltage generator that provides first, second, third, and fourth reference voltages;
a first bit serial transmitter device that establishes a first and second differential voltage between a first and second conductor of a first two-conductor transmission line based on the first and second reference voltages; and
a second bit serial transmitter device that establishes a first and second differential voltage between a first and second conductor of a second two-conductor transmission line based on the third and fourth reference voltages.

16. A system of bit serial transmitter channels as recited in claim 15,
wherein the first bit serial transmitter device is a transmitter device as recited in claim 1, and
wherein the first voltage is connected to the first reference voltage and the second voltage is connected to the second reference voltage.

17. A system of bit serial transmitter channels as recited in claim 15,
wherein the second bit serial transmitter device is a transmitter device as recited in claim 1, and
wherein the first voltage is connected to the third reference voltage and the second voltage is connected to the fourth reference voltage.

18. A bit serial receiver device comprising:
a coupling capacitor connected in series between a single conductor transmission line and a receive node;
an active resistance device for providing a voltage source and a resistance between the receive node and the voltage source, the voltage source setting a voltage threshold for the receiver;
an inverting transconductance amplification element connected to an output of the active resistance device, the inverting element operative to invert the output of the active resistance device; and
a feedback path connected between an output and an input of the inverting transconductance amplification element, the feedback path providing hysteresis to the voltage source of the active resistance device.

19. A bit serial receiver device as recited in claim 18, wherein the inverting transconductance amplification element is a CMOS inverter.

20. A bit serial receiver device as recited in claim 18, further comprising an additional inverting transconductance amplification element for amplifying the output of the inverting transconductance amplification element to provide a full logic level swing at the additional element output.

21. A bit serial receiver device as recited in claim 20, wherein the additional inverting transconductance amplification element is a CMOS inverter.

22. A bit serial receiver device as recited in claim 18, wherein the active resistance device is a CMOS inverter with its output connected to its input.

23. A bit serial receiver device as recited in claim 18, wherein the feedback path is a resistor.

24. A bit serial receiver device as recited in claim 18,
wherein the active resistance device is a CMOS inverter with its output connected to its input, the CMOS inverter including a PMOS transistor and an NMOS transistor having matched characteristics; and
wherein the feedback path is a CMOS inverter having an NMOS and PMOS transistors that are matched to but weaker than the NMOS and PMOS transistors, respectively, of the active resistance device.

25. A bit serial receiver device as recited in claim 24, wherein the input resistance is the reciprocal of the transconductance of the CMOS transistors of the CMOS inverter.

26. A bit serial receiver device as recited in claim 25, wherein the input resistance is approximately 550 ohms.

27. A bit serial receiver device as recited in claim 24, wherein the input resistance and the coupling capacitor form a high pass filter for signals on the single conductor transmission line.

28. A bit serial receiver device as recited in claim 27, wherein the coupling capacitor has a value of approximately 0.6 pF and the input resistance is approximately 550 ohms.

29. A method for receiving a bit serial transmission, the method comprising:
receiving a bit serial differential transmission via a high pass filter;
determining whether or not a received transmission exceeds a threshold of a level-triggered latch; and
if the received transmission exceeds the threshold, changing the state of the level-triggered latch and clamping the received transmission to a voltage provided by the level-triggered latch.

30. A method for receiving a bit serial transmission, the method comprising:
receiving a bit serial single-ended transmission via a high pass filter;
determining whether or not a received transmission exceeds a threshold of an active resistance device; and
if the received transmission exceeds the threshold, changing the state of an inverting transconductance amplification element connected to the active resistance device, altering the threshold of the active resistance device, and clamping the received transmission to a voltage provided by the active resistance device.

31. A method for receiving a bit serial transmission, as recited in claim 30,
wherein the received transmission includes a voltage change of a particular polarity; and
wherein step of altering the threshold includes moving the threshold by a voltage whose polarity is opposite to the polarity of the received transmission.
